(19) United States
(12) Patent Application Publication
(10) Pub. No.: US 2005/0255308 A1
(43) Pub. Date: Nov. 17, 2005

(54) Aerated concrete exterior wallboard sheet and associated method for making

(75) Inventors: Frederick Browne Gregg, Leesburg, FL (US); Mitchell Van Beek, Leesburg, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Consolidated Minerals, Inc., Leesburg, FL (US)

(21) Appl. No.: 11/126,089

(22) Filed: May 10, 2005

Related U.S. Application Data
(60) Provisional application No. 60/570,108, filed on May 11, 2004.

(51) Int. Cl. B32B 31/00

(52) U.S. Cl. 428/312.4; 156/39

(57) ABSTRACT

An exterior wallboard sheet includes a core having opposing first and second major surfaces. The core may include a monolithic body of aerated concrete. At least one water vapor-permeable, water-resistant face layer may be secured on at least one of the first and second major surfaces of the core. The water vapor-permeable, water-resistant face layer may include a microporous polymer layer. The microporous polymer layer may include a woven polypropylene fabric layer having a plurality of microperforations therein.

### RELATED APPLICATION

This application is based upon prior filed copending provisional application Ser. No. 60/570,108 filed May 11, 2004, the entire subject matter of which is incorporated herein by reference in its entirety.

### FIELD OF THE INVENTION

The invention relates to the field of construction products, and, more particularly, to the field of structural and non-structural sheathing products.

### BACKGROUND OF THE INVENTION

Wallboard sheets are widely used in building construction to form partitions or walls of rooms, elevator shafts, stair wells, ceilings, etc. The sheets are typically fastened to a suitable supporting framework. The seams between sheets are covered to provide an even wall surface. The sheets may be readily cut to size by first scoring the face sheet, and then snapping the board about the score line. The wall may then be painted or covered with a decorative wall covering, if desired. Such wallboard sheets created from a gypsum core with outer face layers of paper, sometimes referred to as gypsum board or drywall, are well known.

Gypsum wallboard is typically manufactured by delivering a slurry or paste containing crushed gypsum rock onto a moving sheet of facing paper to which a second or top paper layer is then added to form a long board line. The board line permits the slurry to harden before being cut. The cut panels are heated in a kiln, before being packaged for storage and shipping.

Typically, such sheets are ½ or ⅝ inch thick and in conventional sizes of 4×8 feet, such a gypsum wallboard sheet may weigh about 55-70 pounds. Accordingly, handling of such gypsum wallboards presents a significant task for construction personnel or wallboard “hangers”, particularly when such boards are secured overhead to form a ceiling. In addition, the fire resistance, thermal insulation and sound absorbing properties of conventional gypsum wallboard sheets may not be sufficient for some applications.

Another variation of gypsum wallboard is water-resistant drywall or “greenboard”. The greenboard typically includes the same gypsum core, but includes a water-resistant facing so the water is less likely to penetrate, stain and/or decay the wall. Greenboard is typically used for walls in a moist or humid environment, such as a bathroom, for example. Such greenboard is not typically recommended as an underlayment for tile in the bathroom, for example, since water may penetrate the grout or cracks between adjacent tiles and deteriorate the greenboard. U.S. Pat. No. 5,552,187 to Green et al. discloses the addition of a fibrous mat-faced gypsum board coated with a water-resistant resinous coating for greater durability in moist environments.

Yet another related conventional wallboard product to serve as an underlayment for wet areas is the concrete backerboard. For example, UTIL-A-CRETE® Backerboard from Bonsal is a precast cementitious backboard with glass mesh reinformcement. The board includes portland cement, fiber glass mesh and lightweight aggregate. The backerboard is more adapted to be used in areas subject to splashing or high moisture.

While the glass mesh face layers are typically secured to the surface of the backerboard after the core has been precast, continuous production is also disclosed in U.S. Pat. No. 5,221,386 to Ensminger et al. In addition, the mesh or reinforcing layers have also been embedded in the faces and edges of the backerboards.

Unfortunately, conventional cementitious backerboards may be more difficult to score and break to size. Moreover, since the backerboards include a core of cement, their density is considerably greater than even conventional gypsym wallboard. Accordingly, manufacturers may offer the backerboards in smaller sizes to be more readily handled by the installer, but such increases seams between sheets and also increases costs of installation. A typically-sized 4 foot by 8 foot sheet can weigh well over 100 pounds, which is very unwieldy especially in confined spaces.

Additionally, other structural and non-structural sheathing products include plywood and oriented strandboard (OSB). For example, plywood is made by shaving thin strips or plys of veneer from logs. After the veneer has been dried and graded, adhesive is applied to the wood strips. Each layer of veneer is oriented at 90 degrees to the one just above or below it. The glued pieces of veneer are then placed in a hot press. The heat and pressure allow the glue to penetrate deeply into the wood fibers producing a lasting bond. The layering or cross lamination of the plys is vital as it gives the plywood superior strength and stiffness. The cross layering also minimizes expansion, contraction and eliminates splitting.

OSB is made in basically the exact same fashion. Instead of using large sheets of solid wood veneer, thousands of 3 and 4 inch long strands of solid wood are combined to make each sheet of OSB. High technology manufacturing equipment has the ability to orient the strands so they overlap and interlock at a 90 degree angle. Each strand of wood is completely coated with a high performance resin glue, and the glued pieces are then placed in a hot press.

Also, impregnated fiberboard has been used as insulative sheathing for years and is known by such names as blackboard, grayboard, or buffaloboard. Cementitious board is a panel comprising Portland cement reinforced with fiberglass mesh material. Typically used as backerboard for ceramic tile installations, cement board products have been used as exterior sheathing under a stucco cladding. Not structural in nature, buildings sheathed with cement board require corner bracing.

Fiber cement flat panels have a mix of wood fiber and cement and may be used under stucco and/or as both sheathing and cladding. Again, corner bracing may be required. Fiber cement products are marketed under the Hardi-panel or Cemplank brands by James Hardi, and WeatherBoard brand by CertainTeed Corporation.

Any of the above exterior wallboards may be prone to creating moisture problems when used as the exterior sheathing in a building. The moisture problems may include wood rot, reduced insulation values, mold growth and the like. To address this problem many builders employ some form of house wrap to provide a moisture barrier. U.S. Published Application No. 2004/0180195 to Macuga, which is incorporated by reference in its entirety herein, discloses a breathable water resistant housewrap for attachment to a building after installation of the exterior wallboards and prior to the installation of the siding. The housewrap includes an adhesive layer on one side for securing the housewrap to the exterior wallboards.

U.S. Pat. No. 5,895,301 to Porter et al., which is incorporated by reference in its entirety herein, discloses a breathable water resistant barrier housewrap made from a fiber reinforced mat of a porous web material. The housewrap is easily hand-torn, but is strong enough for exterior applications.

U.S. Pat. No. 6,444,302 to Srinivas et al., which is incorporated by reference in its entirety herein, discloses a breathable water resistant film produced without fillers or the lamination of multiple layers. The film comprises a blend of a soft polymer component and a hard polymer component and is cold-drawn.

Unfortunately, the conventional wallboards used for sheathing may be prone to moisture problems due to being too porous or not porous enough. As a result, builders use housewrap to help protect a building from the moisture problems created by the conventional exterior wallboards used for sheathing.

### SUMMARY OF THE INVENTION

In view of the foregoing background, it is an object of the invention to provide an exterior wallboard that is relatively lightweight, strong, has good fire resistance, thermal insulation, sound absorbing properties, and with improved moisture control characteristics.

This and other objects, features and advantages in accordance with the invention are provided by an exterior wallboard sheet that may include a core having opposing first and second major surfaces. The core may include a monolithic body of aerated concrete. A water vapor-permeable, water-resistant face layer may be secured on one of the first and second major surfaces of the core. Accordingly, an exterior wallboard is provided that is relatively lightweight, strong, has good fire resistance, thermal insulation, sound absorbing properties, and with improved moisture control characteristics.

The water vapor-permeable, water-resistant face layer may comprise a microporous polymer layer. The microporous layer may be formed by drawing the polymer layer, by laying the polymer strands in a pattern or by other techniques as will be appreciated by those of skill in the art. The microporous polymer layer may comprise at least one woven polypropylene fabric layer having a plurality of microperforations therein.

The water vapor-permeable, water-resistant face layer may comprise ultraviolet light-resistant outer surface portions. The ultraviolet light-resistant outer surface portions may comprise an ultraviolet light-resistant polyolefin. An adhesive layer may secure the vapor-permeable, water-resistant face layer to adjacent portions of the core. The adhesive layer may be pressure sensitive.

The core may further comprise a pair of opposing side edges and the vapor-permeable, water-resistant face layer extends around the opposing side edges. The core may comprise a monolithic body of autoclaved aerated concrete having a density of about 25 to 40 lbs./ft³.

A method of the invention is directed to making an exterior wallboard sheet. The method may include forming a core having opposing first and second major surfaces and where the core may include a monolithic body of aerated concrete. The method may further include securing a water vapor-permeable, water-resistant face layer on at least one of the first and second major surfaces of the core.

### BRIEF DESCRIPTION OF THE DRAWINGS

FIG. 1 is a schematic view of a portion of a wall structure including the wallboard and/or backerboard in accordance with the present invention with various layers removed for clarity of explanation.

FIG. 2 is a perspective view of a wallboard sheet as can be used in the wall structure of FIG. 1.

FIG. 3 is an enlarged cross-sectional view through a side edge of the wallboard sheet as shown in FIG. 2.

FIG. 4 is a perspective view of another embodiment of a wallboard sheet as can be used in the wall structure of FIG. 1.

FIG. 5 is an enlarged cross-sectional view through a beveled portion of the wallboard sheet as shown in FIG. 4.

FIG. 6 is a perspective view of a backerboard sheet as can be used in the wall structure of FIG. 1.

FIG. 7 is an enlarged cross-sectional view through a side edge of the backerboard sheet as shown in FIG. 6.

FIG. 8 is a perspective view of another embodiment of a backerboard sheet as can be used in the wall structure of FIG. 1.

FIG. 9 is an enlarged cross-sectional view through a beveled portion of the backerboard sheet as shown in FIG. 8.

FIG. 10 is a flowchart for a first embodiment of a method for making wallboard and/or backerboard sheets in accordance with the invention.

FIG. 11 is a flowchart for a second embodiment of a method for making wallboard and/or backerboard sheets in accordance with the invention.

FIG. 12 is a flowchart for a third embodiment of a method for making wallboard and/or backerboard sheets in accordance with the invention.

FIG. 13 is a flowchart for a fourth embodiment of a method for making wallboard and/or backerboard sheets in accordance with the invention.

FIG. 14 is a schematic block diagram of a system for making wallboard and/or backerboard sheets in accordance with the invention.

FIG. 15 is a more detailed schematic diagram of a former embodiment for the system as shown in FIG. 14.

FIG. 16 is a more detailed schematic diagram of an alternative portion of the former embodiment as shown in FIG. 15.

FIG. 17 is a more detailed schematic of another former embodiment and variation thereof for the system of FIG. 14.

FIG. 18 is a more detailed schematic of still another former embodiment and variation thereof for the system of FIG. 14.

FIG. 19 is a perspective view of an exterior wallboard sheet.

FIG. 20 is an enlarged cross-sectional view through a side edge of the exterior wallboard sheet as shown in FIG. 19.

FIG. 21 is a more detailed schematic diagram of an alternative portion of the former embodiment as shown in FIG. 15.

FIGS. 22-24 are more detailed schematic diagrams of the tilting station for the former embodiment of FIG. 21.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

The present invention is based, at least in part, upon the recognition of the various shortcomings of prior art gypsum wallboard and/or cementitious backerboard sheets, and the further recognition that the use of aerated concrete as the core material overcomes a number of the shortcomings. As it is also known autoclaved aerated concrete is a high-quality, load-bearing, as well as insulating building material produced in a wide range of product sizes and strengths. The material has been used successfully in Europe and is now among widely used wall building materials in Europe with increasing market shares in other countries.

Aerated concrete is a steam cured mixture of sand or pulverized fuel ash, cement, lime and an aeration agent. High pressure steam curing in an autoclave produces a physically and chemically stable product with an average density being about one fifth that of normal concrete. The material includes non-connecting air cells, and this gives aerated concrete some of it its unique and advantageous properties. Aerated concrete enjoys good strength, low weight, good thermal insulation properties, good sound deadening properties, and has a high resistance to fire.

Aerated concrete may be used in the form of panels or individual building blocks. It has been used for residences; commercial, industrial and agricultural buildings; schools; hospitals; etc. and is a good material in most all climates. Panels or blocks may be joined together using common mortar or thin set glue mortar or adhesive. Aerated concrete has durability similar to conventional concrete or stone and a workability perhaps better than wood. The material can be cut or sawn and readily receives expandable fasteners. Aerated concrete has a thermal conductivity six to ten times better than conventional concrete. The material is also non-rotting, non-toxic and resistant to termites.

As disclosed in U.S. Pat. No. 4,902,211 to Svanholm, for example, aerated concrete may typically be produced as follows. One or several silica containing materials, such as sand, shale ashes or similar materials, as well as one or more calcareous binders, such as lime and/or cement, are mixed with a rising or aeration agent. The aeration agent typically includes aluminum powder which reacts with water to develop hydrogen gas at the same time a mass of what can be considered a calcium silicate hydrate forms. The development of hydrogen gas gives the mass macroporosity. The rising mass is typically contained within a mold. After rising, the mass is permitted to stiffen in the mold forming a semiplastic body which has low strength, but which will keep together after removal from the mold.

After a desired degree of stiffness is achieved and the body is removed from the mold, the body may typically be divided or cut by wires into separate elements having the desired shape, such as building blocks or larger building panels. The divided body is positioned in an autoclave where it is steam cured at high pressure and high temperature to obtain suitable strength. The body is then advanced to a separation station where the adjacent building blocks or panels are separated from one another. The blocks are packaged, such as onto pallets for storage and transportation.

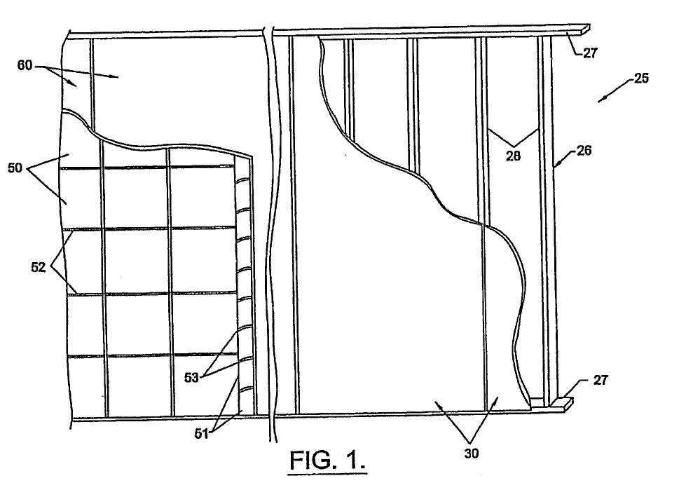

Referring now initially to FIGS. 1-5 a wallboard sheet 30 in accordance with the present invention is now described. The wallboard sheet 30 may be used to form part or all of an interior wall structure, such as the right hand portion of the wall structure 25 (FIG. 1). Of course, the wallboard sheet 30 could be used for ceilings, interior partitions, elevator shafts, etc, as will be appreciated by those skilled in the art. The wall structure 25 will typically include a frame 26 formed of horizontal and vertical wall studs or members, 27, 28, respectively, to which the wallboard sheets 30 are secured by suitable fasteners and/or adhesive.

The wallboard sheet 30 includes a core 40 having opposing first and second major surfaces 40a, 40b, respectively, and at least one face layer on at least one of the first and second major surfaces of the core. The core 40 includes aerated concrete. The provision of aerated concrete for the core provides many key advantages over conventional wallboard sheets, such as gypsum wallboard, for example. The core 40 may be produced from a mixture of Portland cement, quick lime, sand, aluminum powder and water, although at least some of the sand and perhaps some of the quick lime can be replaced by flyash. In general, the flyash may be used as at least a partial replacement for sand in the mix, but flyash, depending on its composition, may react with the aluminum powder in a manner similar to quick lime to produce the micro-cellular bubbles in the expanded aerated concrete.

In the first embodiment of the wallboard sheet 30, both first and second face layers 42a, 42b, respectively, are adhesively secured to the opposing first and second major surfaces 40a, 40b of the core 40 via respective adhesive layers 43a, 43b. In other embodiments, the adhesive may be incorporated into the face layers and/or the surface portion of the aerated concrete core as will be appreciated by those skilled in the art. One or both of the face layers 42a, 42b may comprise paper, having colors and/or weights, for example, similar to conventional gypsum wallboard paper.

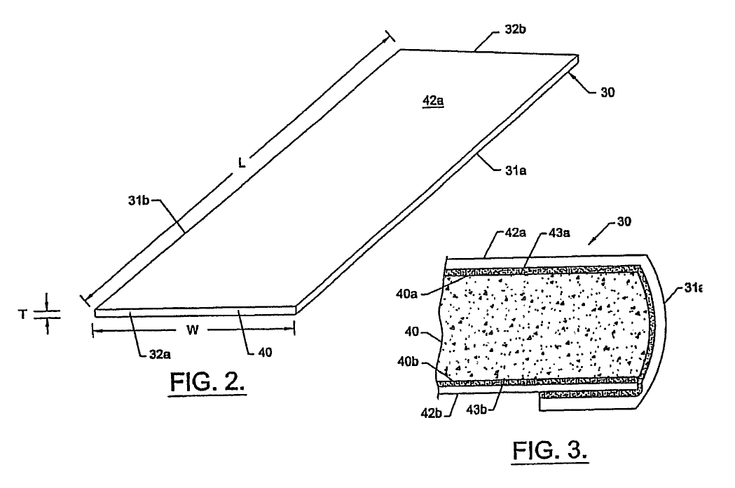

The core 40 and hence the wallboard sheet 30 may have a generally rectangular shape defining a pair of opposing side edges 31a, 31b, respectively, and a pair of opposing end edges 32a, 32b, respectively. The first face layer 42a may extend around the opposing side edges 31a, 31b as shown perhaps best in the enlarged cross-sectional view of FIG. 3. In addition, the opposing end edges 32a, 32b of the core may be exposed (FIG. 2). If desired, a tape, not shown, may be provided on the opposing ends 32a, 32b as will be appreciated by those skilled in the art.

The aerated concrete core 40 may have a relatively low density in a range of about 25 to 40 lbs./ft.³ The core 40 and hence the sheet 30, as well, may also have a thickness T in a range of about ¼ to 1 inch, a width W in a range of about three to five feet, and a length L in a range of about five to sixteen feet. Accordingly, even a 1 inch thick, 4 foot by 8 foot wallboard sheet 30 may have a relatively low total weight of about 60 pounds.

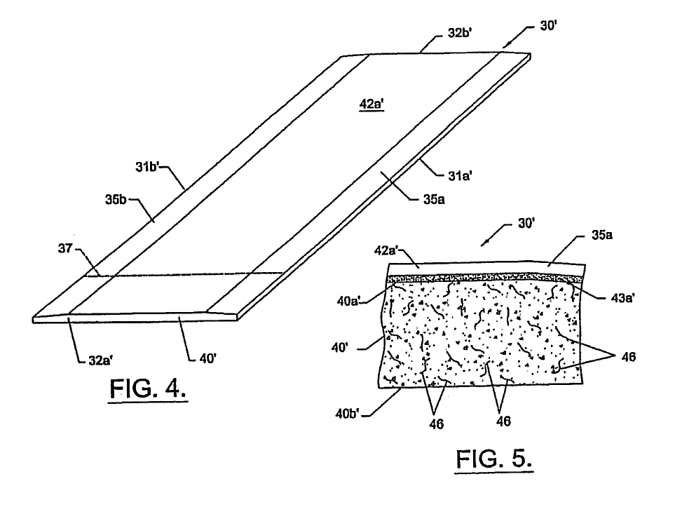

Referring now more particularly to the embodiment of the wallboard sheet 30′ shown in FIGS. 4 and 5, other aspects of the invention are now explained. The illustrated wallboard sheet 30′ includes beveled portions 35a, 35b formed on the first major surface 40a′ of the core 40′ adjacent respective opposing side edges 31a′, 31b′. The beveled portions 35a, 35b may facilitate the receipt of taping and joint compound to cover the joints between adjacent sheets 30′ in the finished wall structure.

As perhaps best shown in FIG. 5, the illustrated embodiment of the wallboard sheet 30′ also includes only a single face layer 42a′, although in other embodiments, a second face layer may be applied as well. In addition, the illustrated embodiment of the core 40′ includes schematically illustrated reinforcing fibers 46. The fibers 46 may be provided by a fibrous material, such as cellulose or other natural or synthetic fibers, including fiberglass, metal or other materials, to impart strength to the core and reduce the relative brittleness of the aerated concrete.

Another aspect of the wallboard sheet 30′ is that it includes a joint schematically illustrated by the dashed line 37 extending across the width of the sheet as may be formed during the manufacturing thereof and as will be explained in greater detail herein. The joint 37 can be stronger than the adjacent core material, and without compromising the ability to score and snap break the wallboard sheet 30′ as conveniently as with conventional gypsum wallboard. Stated slightly differently, some embodiments of the wallboard sheet 30′ may include first and second portions on opposite sides of the joint 37 aligned in end-to-end relation at respective opposing edges thereof, and an adhesive layer may be used to join the opposing edges of the first and second portions together.

The other elements of the wallboard sheet 30′ indicated with prime notation and not specifically mentioned are similar to those elements described above with reference to the wallboard sheet 30 described above. Accordingly, these elements need no further discussion herein. Those of skill in the art will also appreciate that the various features of the embodiments of the wallboard sheets 30, 30′ can be mixed and/or substituted in yet further embodiments of the invention.

Because of the relative light weight of the wallboard sheets 30, 30′ including aerated concrete, shipping, handling, and installation at a job site are facilitated. In addition, the substitution of aerated concrete for gypsum, for example, also offers the advantages of increased fire resistance, thermal insulation, sound deadening, and other properties in a wall structure formed by fastening the aerated concrete wallboard sheets to a suitable building frame.

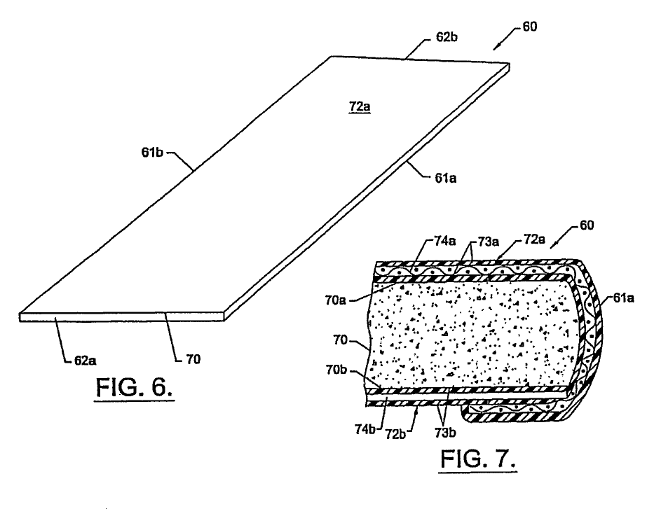

Returning again briefly to FIG. 1 and additionally to FIGS. 6-9, a backerboard sheet 60 in accordance with the present invention is now described. More particularly, as shown in the left hand portion of FIG. 1, the backerboard sheets 60 may be used where the wall is likely to be exposed to splashing water or moisture, such as a bathroom, and other indoor areas as will be appreciated by those skilled in the art. The backerboard sheet 60 is also typically used as an underlayment substrate for decorative area tile 50 and/or border tile 51 as shown in the left hand portion of FIG. 1. Adjacent ones of the tiles 50, 51 typically include grout lines 52, 53 therebetween through which moisture may penetrate. In addition, cracks may form in the grout lines or the tiles themselves through which moisture may also penetrate.

Conventional gypsum greenboard or cementitious sheets for such high-moisture applications suffer a number of significant shortcomings and disadvantages as highlighted in the background of the invention section above. The backerboard sheet 60 including a core 70 comprising aerated concrete, and at least one moisture-resistant face layer overcomes these shortcomings and disadvantages.

In the first illustrated embodiment of the backerboard sheet 60, both first and second moisture-resistant face layers 72a, 72b, respectively, are secured to the opposing first and second major surfaces 70a, 70b of the core 70. Each moisture-resistant face layer 72a, 72b illustratively includes a woven fiber mesh 74a, 74b incorporated into a respective resin layer 73a, 73b. The fibers may include at least one of glass, plastic, and metal. The moisture-resistant face layer may have other constructions and be formed of different moisture-resistant materials, such as those commonly used for cementitious backerboard, and others as will be appreciated by those skilled in the art. For example, moisture resistant face layers include nylon, aramid resin, or metal fibers as disclosed in U.S. Pat. No. 5,221,386 may also be used, and the entire contents of this patent are incorporated herein by reference.

The core 70 and hence the backerboard sheet 60 may also have a generally rectangular shape defining a pair of opposing side edges 61a, 61b, respectively, and a pair of opposing end edges 62a, 62b, respectively. The first face layer 72a may also extend around the opposing side edges 61a, 61b as shown perhaps best in the enlarged cross-sectional view of FIG. 7. In addition, the opposing end edges 72a, 72b of the core may be exposed (FIG. 6). If desired, a tape, not shown, may be provided on the opposing ends 62a, 62b as will be appreciated by those skilled in the art. In addition, the aerated concrete core 70 may have the same characteristics and sizes as mentioned above with respect to the wallboard sheets 30, 30′, for example.

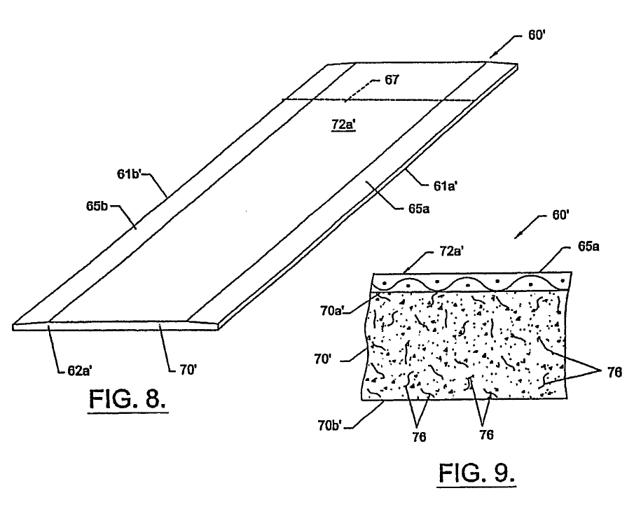

Referring now more particularly to the embodiment of the backerboard sheet 60′ shown in FIGS. 8 and 9, other aspects of the invention are now explained. The illustrated backerboard sheet 60′ includes beveled portions 65a, 65b formed on the first major surface 70a′ of the core 70′ adjacent respective opposing side edges 61a′, 61b′. The beveled portions 65a, 65b may facilitate the receipt of taping and sealing or joint compound to cover the joints between adjacent sheets 60′ in the finished wall structure.

As perhaps best shown in FIG. 9, the illustrated embodiment of the backerboard sheet 60′ also includes only a single moisture-resistant face layer 72a′, although in other embodiments, a second face layer may be applied as well. The moisture-resistant face layer 72a′ is also illustratively directly secured to the core 70, although an incorporated resin or adhesive may be used in other embodiments.

The illustrated embodiment of the core 70′ includes schematically illustrated reinforcing fibers 76. The fibers 76 may be provided by a fibrous material, such as cellulose or other natural or synthetic fibers, including fiberglass, metal or other materials, to impart strength to the core and reduce the relative brittleness of the aerated concrete. The fibers may also be desirably selected to avoid attracting or retaining moisture.

Another aspect of the backerboard 60′, similar to the wallboard 30′ discussed above, is that it includes a joint schematically illustrated by the dashed line 67 extending across the width of the sheet as may be formed during the manufacturing thereof and as will be explained in greater detail herein. The joint 67 can also be stronger than the adjacent core material, and without compromising the ability to score and snap break the backerboard sheet 60′. In other words, the backerboard sheet 60′ may include first and second portions on opposite sides of the joint 67 aligned in end-to-end relation at respective opposing edges thereof, and an adhesive layer may be used to join the opposing edges of the first and second portions together.

The other elements of the backerboard sheet 60′ indicated with prime notation and not specifically mentioned are similar to those elements described above with reference to the backerboard sheet 60 described above. Accordingly, these elements need no further discussion herein. Those of skill in the art will also appreciate that the various features of the embodiments of the wallboard sheets 60, 60′ can be mixed and/or substituted in yet further embodiments of the invention. Because of the relative light weight of the backerboard sheets 60, 60′ including aerated concrete, shipping, handling, and installation at a job site are facilitated.

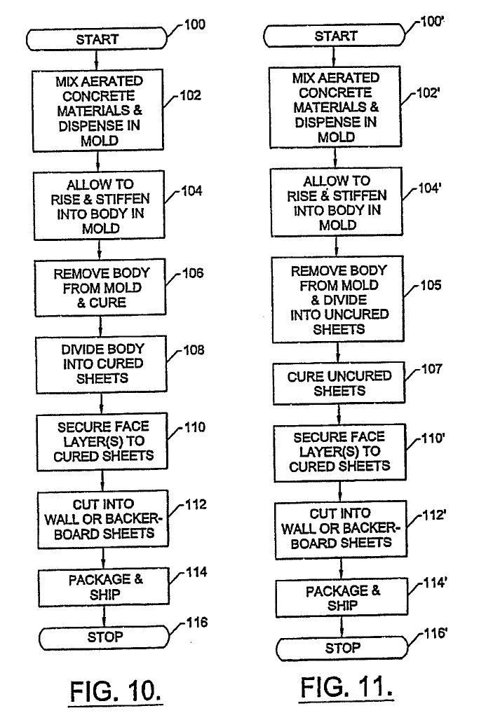

Turning now additionally to the flowcharts of FIGS. 10-13 various method aspects for making the wallboard and/or backerboard sheets in accordance with the invention are now described. The method may include forming core material having opposing first and second major surfaces and comprising aerated concrete, securing at least one face layer on at least one of the first and second major surfaces of the core material, and cutting the core material and at least one face layer secured thereto into a plurality of wallboard or backerboard sheets. The provision of aerated concrete for the core provides many key advantages over conventional gypsum wallboard sheets, and/or conventional backerboard sheets, such as gypsum greenboard or cementitious backerboard, for example.

In one class of embodiments, the method may further comprise curing the core material prior to securing the at least one face layer thereto. In another class, the method may further comprise curing the core material after securing the at least one face layer thereto.

Referring now to the flowchart of FIG. 10, a particularly advantageous embodiment is described wherein curing is performed before adding the at least one face layer. In particular, from the start (Block 100), the materials for making aerated concrete are mixed and dispensed into a suitable mold at Block 102. The materials are permitted to rise and stiffen into a body (Block 104), and the body may then be removed from the mold (Block 106). The body having a size of about twenty feet in length, four feet in height, and two feet in width is cured at Block 108, such as by positioning in an autoclave as will be appreciated by those skilled in the art. The one or more face layers can then be secured to the cured sheets of the core material at Block 110. Thereafter, the core material with the face layer(s) secured thereto can be cut to the desired lengths to form the wallboard or backerboard sheets at Block 112 before packaging/shipping (Block 114) and stopping or ending the method at Block 116.

In other words, in this embodiment forming the core material comprises dispensing materials for making aerated concrete into a mold and allowing the materials to rise and stiffen into a body, curing the body, and dividing the cured body into a plurality of cured sheets to serve as the core material. The plurality of the cured sheets may be joined together in end-to-end relation while advancing the cured sheets along a path of travel. In addition, securing the at least one face layer may be performed while the cured sheets are advanced along the path of travel.

A variation of this method embodiment is now explained with reference to the flowchart of FIG. 11. In this embodiment, prime notation is used to indicated similar steps which need no further explanation. In accordance with the illustrated embodiment of FIG. 11, the body is divided, but not separated or cut, into sheets at Block 105, and is then cured at Block 107. Thereafter, the cured sheets are used as the core material and to which the face layer(s) are secured as described above. This embodiment may offer the advantage of slightly easier cutting of the body, since it has not been fully cured; however, the ultimate dimensional accuracy of the sheets may be less compared to first curing the body and then cutting the body into cured sheets. Of course, a combination of some cutting or shaping before curing and further cutting or shaping after curing are also contemplated by the present invention.

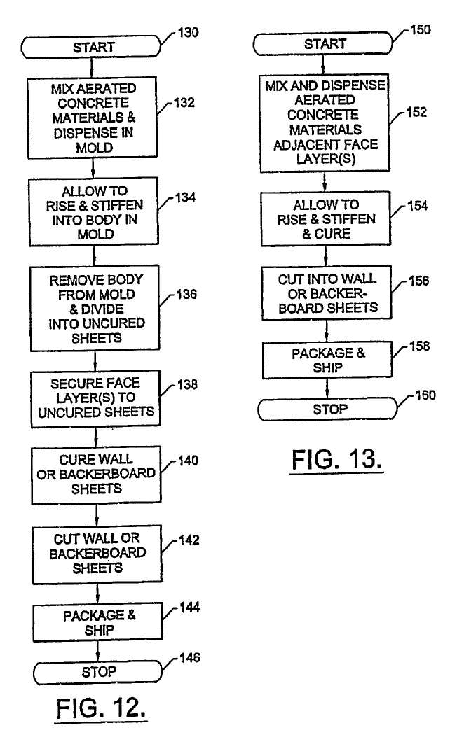

Referring now more particularly to the flow charts of FIGS. 12 and 13, the second class of method embodiments, wherein the one or more face layers are added before final curing, are now described. It is noted that final curing using a conventional autoclave may place relatively difficult requirements on the characteristics of the face layers in terms of temperature resistance and/or abrasion resistance. Accordingly, manufacturing speed or efficiency may need to be considered in view of the increased face layer material costs as will be appreciated by those skilled in the art.

The first embodiment is now described with reference to the flowchart of FIG. 12. From the start (Block 130), the materials for making aerated concrete are mixed and dispensed into a suitable mold at Block 132. The materials are permitted to rise and stiffen into a body (Block 134), and the body may then be removed from the mold and divided into uncured sheets (Block 136). The one or more face layers may be secured to the uncured sheets at Block 138, which can then be cured (Block 140), before being cut into desired lengths at Block 142. The final sheets may be packaged and shipped at Block 144 before stopping or ending the method at Block 146. Of course, the final curing could also be performed prior to the cutting into individual sheets as will be appreciated by those skilled in the art.

Referring now to the flowchart of FIG. 13, yet another embodiment of the method is now described. This embodiment is directed to a more continuous manufacturing operation. More particularly, from the start (Block 150) the materials for making aerated concrete are dispensed in slurry form onto at least one face layer (Block 152), typically as the face layer is advanced along a conveyor, for example. The slurry may alternatively be dipensed onto a surface, e.g. a stainless steel surface, instead of directly onto the face layer. The dwell time on the conveyor may desirably be sufficient to allow the materials to rise and stiffen, and optionally cured, (Block 154) before cutting into final lengths (Block 156). Thereafter, the sheets may be packaged and shipped at Block 158 before stopping (Block 160). Of course in other embodiments, it is also possible to cut the core material before final curing. This may be especially desirably where conventional autoclave curing is performed which may require a relatively long dwell time in the heated chamber. However, other curing techniques, such as the addition of microwave radiation are also contemplated which may provide for near continuous curing of the core material as will also be appreciated by those skilled in the art.

Of course, in all of the specifically described and contemplated method embodiments, the securing of the at least one face layer may comprise securing first and second face layers on respective first and second major surfaces of the core material. The at least one face layer may comprise paper, such as for a wallboard. Alternately, the at least one face layer may be moisture-resistant for a backerboard. Forming may also include forming the first major surface of the core material to have beveled portions adjacent respective opposing longitudinal side edges. In addition, the at least one face layer may be secured to extend around the opposing longitudinal side edges by the use of simple edge wrapping guides, for example. The core material may also be formed with reinforcing fibers in the aerated concrete.

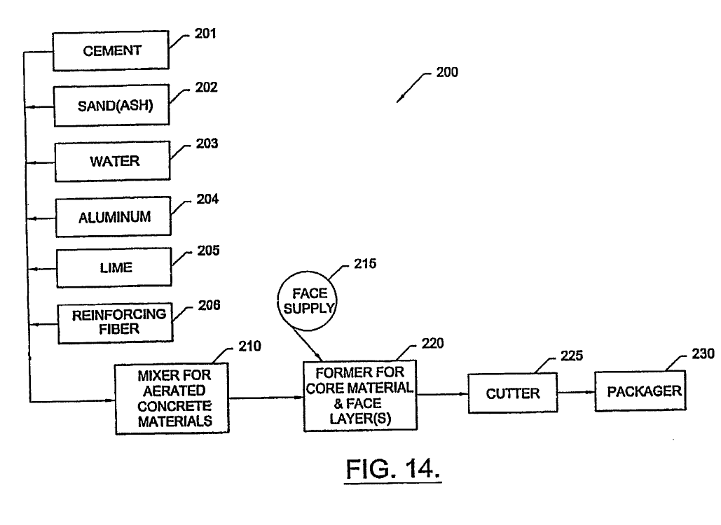

Turning now additionally to FIGS. 14-18 various aspects of a system for making the wallboard and/or backerboard including aerated concrete in accordance with the invention are now described. Starting with the overall simplified schematic diagram of FIG. 14 an illustrated embodiment of the system 200 is now described. The system 200 includes a mixer 210 for mixing materials for making aerated concrete. The mixer 210 is supplied with the starting materials for making aerated concrete from the cement supply 201, the sand (ash) supply 202, the water supply 203, the aluminum or other aeration agent supply 204, the lime supply 205, and the optional reinforcing fiber supply 206. The system also illustratively includes at least one face layer supply 215, a former 220 downstream from the mixer 210 and connected to the face layer supply 215. A cutter 225 is provided downstream from the former 220. And an optional packager 230 is provided, such as to package the wallboard or backerboard sheets onto pallets for shipping, for example.

The former 220 is for forming core material having opposing first and second major surfaces and comprising aerated concrete, and for securing at least one face layer from the at least one face layer supply 215 onto at least one of the first and second major surfaces of the core material. As described below, in one class of embodiments, the former 220 may further include an autoclave for curing the core material prior to securing the at least one face layer thereto. In another class, the former may further include an autoclave or other curing apparatus for curing the core material after securing the at least one face layer thereto.

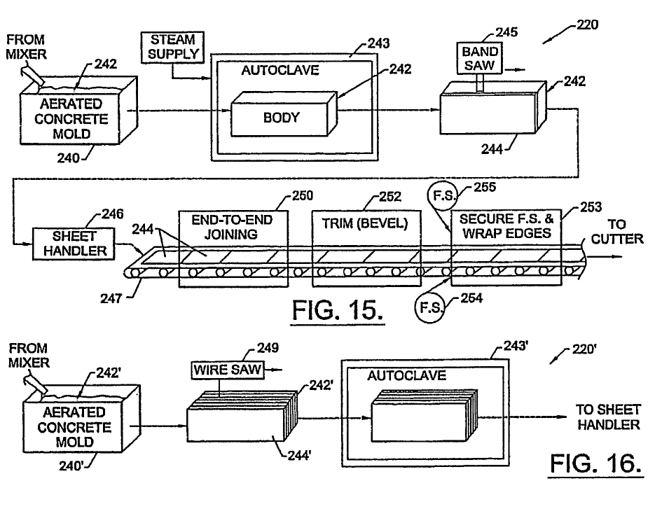

One particularly advantageous embodiment of the system will now be explained with reference to the more detailed schematic diagram of the former 220 as shown in FIG. 15. More particularly, the illustrated embodiment of the former 220 may include a mold 240 downstream from the mixer for receiving the materials for making aerated concrete therein and allowing the materials to rise and stiffen into a body 242. The former 220 also includes the autoclave 243 downstream from the mold 240 for curing the body 242. Of course, the system would also include the necessary material handling mechanisms and apparatus to remove the body 242 and position it as will be appreciated by those skilled in the art.

The former 220 also includes a divider downstream from the autoclave for dividing the cured body 242 into a plurality of cured sheets to serve as the core material. One or more band saws 245, for example, could be used to slice the cured body 242 into a plurality of cured sheets 244. Other types of saws could also be used.

The former 220 may also include a conveyor 247 and a sheet handler 246 cooperating therewith for joining a plurality of the cured sheets 244 together in end-to-end relation while advancing the cured sheets along a path of travel on the conveyor. Alternatively, the cured sheets 244 may not be joined together, but may have already been cut in desired dimensions. The schematically illustrated end-to-end joiner 250 can provide the adhesive, alignment and compressive forces, if needed to insure a quality joint. Downstream from the joiner 250, a trim/bevel station 252 can be used to trim the upper and/or side surfaces of the sheets, and also to form the desired beveled sides if desired.

Both the joiner 250 and trim/bevel station 252 can be readily made from conventional equipment and need no further discussion herein. What is noted, however, is that the aerated concrete is readily workable unlike conventional concrete, for example. A waste collection system may also be provided to collect and recycle trimmed or cut material from the aerated concrete as will be appreciated by those skilled in the art.

Downstream from the trim/bevel station 252, the former 220 also illustratively includes a securing station 253 to apply the one or more face layers from the appropriate supplies 254, 255. This securing station 253 can use conventional layer handling, guiding rolls, etc. to attach the at least one, face layer while the cured sheets 244 are advanced along the path of travel. The securing station 253 can also include the necessary guides and rolls to roll a face layer around the longitudinal side edges as described above.

Turning now briefly to FIG. 16 a variation of the former embodiment described above will now be described. In this embodiment of the former 220′, the body 242′ is cut or divided into sheets 244′ before positioning in the autoclave 243′. As discussed above, while the cutting may be somewhat easier, and a more simple wire saw 249′ may be used, the resulting dimensions of the sheets may not be as accurate. This embodiment does, however, avoid the need for higher temperature compatible/resistant face layers. Of course, combinations of pre-cure and post-cure shaping of the core material may also be used.

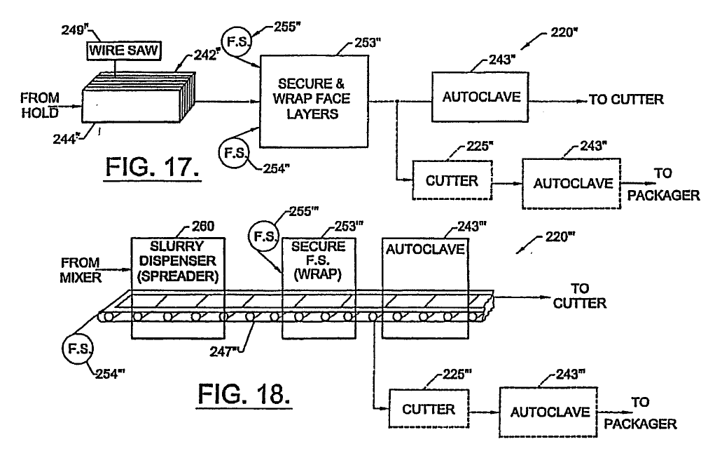

Turning now more particularly to FIG. 17 another variation or embodiment of a former 220″ is now described. In this embodiment, the face layers from the supplies 254″, 255″ are added downstream from dividing the body 242″ into uncured sheets 244″ but before positioning in the autoclave 243″ for curing. As noted above this may increase the requirements and costs for the face layers, but may provide increased manufacturing efficiencies as will be appreciated by those skilled in the art. As shown, uncured sheets 244″ may also be passed through cutter 225″ prior to the autoclave 243″. Of course, the various core shaping operations may also be performed on the uncured sheets to form beveled edges, etc.

A further embodiment of the former 220′″ is described with reference to FIG. 18. This embodiment of the system may provide for near continuous production. In this embodiment, the former 220′″ may comprise a slurry dispenser (and spreader) 260 and a conveyor 247″′ cooperating therewith for dispensing the materials for making aerated concrete adjacent at least one face layer, such as from supply 254″′, as the at least one face layer is advanced along a path of travel. The securing station 253″′ secures the second face layer from the supply 255″′ and may wrap the edges in the illustrated embodiment. Again, the slurry may also be dispensed directly onto a surface, such as a stainless steel surface, instead of onto the at least one face layer, with the first and second face layers being secured by the securing station 253″′ thereafter. In this embodiment, the autoclave or other curing station 243″′ is downstream from the dispenser for curing the materials for making aerated concrete. The autoclave 243″′ may preferably be after the cutter 225″′, for example, but the autoclave or other curing device may be positioned along the conveyor 247″′. Typically, curing takes between 4 and 12 hours at a temperature of about 165° C. and pressure of about 150 psi. It is expected that the time from pouring the mixture onto the conveyor to cutting the sheet into final lengths will vary between 20 and 50 minutes depending on the relative percentage of cement, lime and aluminum.

In any of the embodiments, the former may secure first and second face layers on respective first and second major surfaces of the core material. For wallboard sheets, the at least one face layer supply may comprise at least one paper face layer supply. For backerboard sheets, the at least one face layer supply preferably comprises at least one moisture-resistant face layer supply.

It is also contemplated that the wallboard and backerboard sheets described herein may be produced without the face layers if sufficient strength and surface smoothness can be obtained by use of the fibrous filler material alone, for example. However, it is recognized that any filler material will add weight and that the volume of fibrous material is a trade off with weight and strength or flexibility. Thus, it may be desirable to use just enough fibrous material to produce some slight flexibility without addressing surface smoothing.

Another aspect of the invention is directed to use of the aerated concrete core in an exterior wallboard to be used in residential or commercial construction on the outside of the frame, e.g. as exterior sheathing under stucco cladding or siding. The exterior wallboard could also be used in non- or load-bearing exterior or interior wall, floor, and roof panels. The exterior wallboard could also be used in certain interior applications where water resistance was desired, such as in bathrooms, for example.

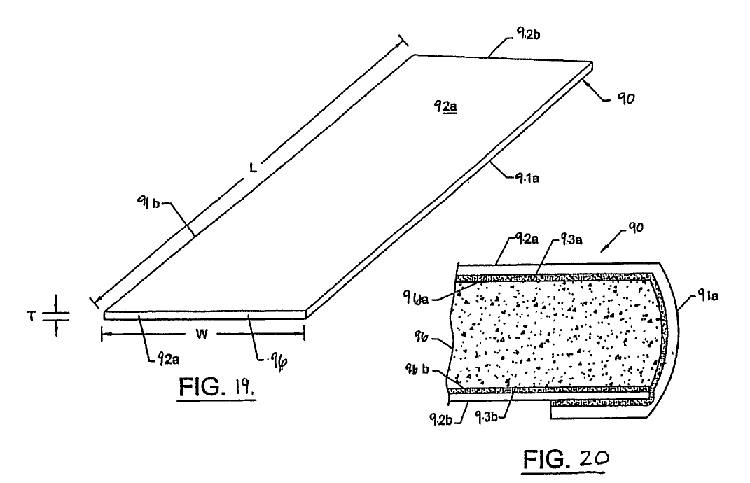

Referring to FIG. 19, the exterior wallboard sheet 90 includes a core 96 having opposing first and second major surfaces 90a, 90b, respectively, and face layers adhesively bond onto the first and second major surfaces of the core. The provision of aerated concrete for the core provides many key advantages over conventional exterior wallboard or sheathing, such as plywood or OSB for example. The core 90 may be produced from a mixture of Portland cement, quick lime, sand, aluminum powder and water, although at least some of the sand and perhaps some of the quick lime can be replaced by flyash.

In this embodiment of the exterior wallboard sheet 90, both first and second face layers 92a, 92b, respectively, are adhesively secured to the opposing first and second major surfaces 96a, 96b of the core 96 via respective adhesive layers 93a, 93b. In other embodiments, the adhesive may be incorporated into the face layers and/or the surface portion of the aerated concrete core or the adhesive may be applied to the surfaces of the core from upper and lower glue stations as will be appreciated by those skilled in the art. The adhesively bonded face layers 92a, 92b, in combination with the aerated concrete core 90, provide a very strong and structurally robust unit as will be appreciated by those of skill in the art.

One or both of the face layers 92a, 92b, but preferably both, preferably comprises a high tensile strength woven polypropylene fabric with a UV-resistant polyolefin coating. Such a face layer is weather and fire resistant and preferably includes distributed microperforations that control the transmission of water vapor from the interior to the exterior to prevent moisture accumulation and condensation, i.e. the face layer is breathable. An example of such a face layer is the FirstWrap product available from Firstline Corporation of Valdosta, Ga. Another similar material is Tyvek® available from DuPont of Wilmington, Del. Other materials may also be used. As will be appreciated by those of skill in the art, joints or seams between adjacent exterior boards may be sealed from air penetration by a pressure sensitive adhesive tape as is commonly used in construction.

The core 96 and hence the exterior wallboard sheet 90 may have a generally rectangular shape defining a pair of opposing side edges 91a, 91b, respectively, and a pair of opposing end edges 92a, 92b, respectively. The first face layer 92a may extend around the opposing side edges 91a, 91b as shown perhaps best in the enlarged cross-sectional view of FIG. 20. The first face layer 92a may be wrapped around to the second major surface 96b of the core 96 and extend over or under the second face layer 92b. In addition, the opposing end edges 92a, 92b of the core may be exposed (FIG. 19). If desired, a tape, not shown, may be provided on the opposing ends 92a, 92b as will be appreciated by those skilled in the art. Structural strength of the exterior wallboard sheet 90 may be attributed to such tightly wrapped face layers 92a, 92b around the aerated concrete core 96.

The aerated concrete core 96 may have a relatively low density in a range of about 25 to 40 lbs./ft.³ The core 96 and hence the sheet 90, as well, may also have a thickness T in a range of about ¼ to 1 inch, a width W in a range of about three to five feet, and a length L in a range of about five to sixteen feet. Accordingly, even a 1 inch thick, 4 foot by 8 foot wallboard sheet 90 may have a relatively low total weight of about 60 pounds.

Moreover, referring to FIGS. 21-24, another embodiment of the former including the use of a tilter, will now be described. More particularly, the illustrated embodiment of the former 320 may include a mold 340 downstream from the mixer for receiving the materials for making aerated concrete therein and allowing the materials to rise and stiffen into a body 342. The former 320 also includes a divider downstream from the mold 340 for dividing the body 342 into a plurality of uncured sheets to serve as the core material. One or more wire or band saws 345, for example, could be used to slice the uncured body 342 into a plurality of uncured sheets 344. For example, the divider may be a vertical cutting unit including sets of hydraulically tensioned reciprocating wires as provided by Stork Building Technology of the Netherlands. Other types of saws could also be used as long as the wires/blades can be spaced close enough together to achieve the desired thickness of the sheets.

The former 320 also includes the autoclave 343 downstream from the divider 349 for curing the group of vertically oriented uncured sheets 344. Of course, the system would also include the necessary material handling mechanisms and apparatus to remove the group of uncured sheets and position it as will be appreciated by those skilled in the art. For example, the group may be transported via a railcar with various support platforms and walls.

A tilting station 360 is provided downstream from the autoclave 343. The tilting station 360 is for tilting a group of cured sheets 344 from the vertical orientation to a horizontal orientation prior to being forwarded to the sheet handler described above. Such a tilting station may be moveable, e.g. via corresponding wheels and tracks, between a plurality of autoclaves and to the sheet handler.

An embodiment of the tilting station 360 will now be described with reference to FIGS. 22-24. The tilting station 360 includes a tilter 370 including a support vehicle 372 comprising a frame 374 and a pivot member 376 carried thereby. A first pivotal platform 378 is connected to the pivot member 376 and extends outwardly therefrom, and a second pivotal platform 379 is connected to the pivot member and extends outwardly therefrom. First and second actuators 381, 382, e.g. hydraulic actuators, are associated with the first and second pivotal platforms for tilting the first and second pivotal platforms among initial load, first tilt, and final tilt positions.

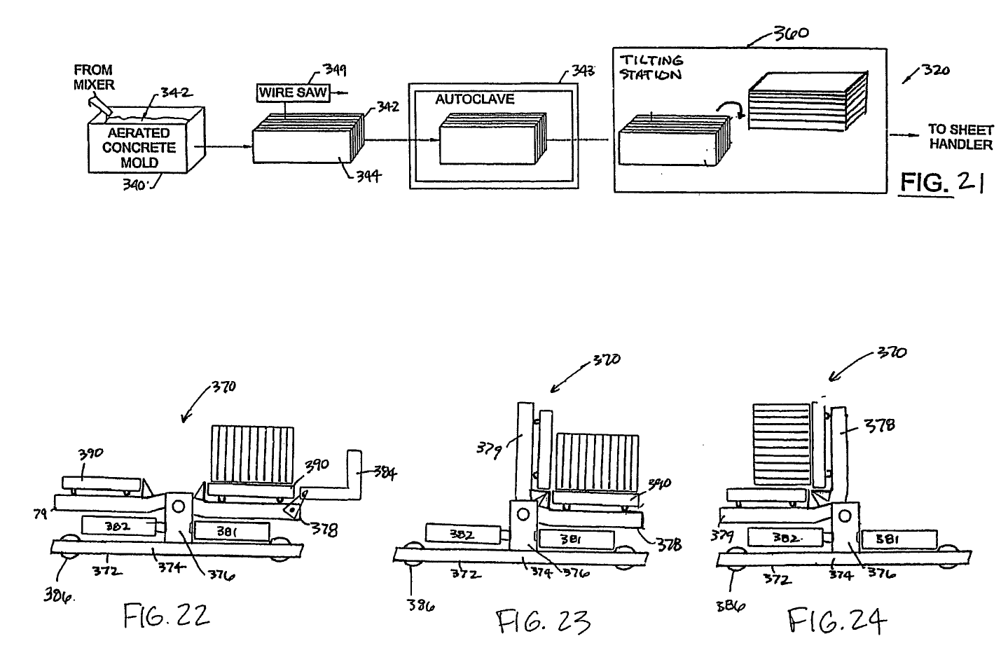

The initial load position is defined by the first and second pivotal platforms 378, 379 being in a horizontal position (FIG. 22), the first tilt position is defined by the first pivotal platform 378 being in a horizontal position and the second pivotal platform 379 being in a vertical position (FIG. 23), and the final tilt position is defined by the first pivotal platform being in a vertical position and the second pivotal platform being in a horizontal position (FIG. 24).

A movable cover 384 may be connected to an end of the first pivotal platform 378 to cover a portion of the sheets when being tilted. A plurality of wheels 386, e.g. railcar wheels, may be carried by the frame 374. The first and second pivotal platforms 378, 379 may each have a rectangular shape and be independently rotatable.

In the illustrated embodiment, the group of cured sheets is transported on a railcar 390 from the autoclave 343 to the tilting station 360 where the first pivotal platform receives the supply railcar, and the second pivotal platform receives the receptacle railcar in the initial load position. As such, the first and second pivotal platforms preferably include corresponding tracks for the railcar wheels.

Other features and advantages are disclosed in U.S. Pat. No. 6,416,619 and published application US 2002-0088524 A1, the entire contents of both of which are incorporated herein by reference. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included.

1. An exterior wallboard sheet comprising:
a core having opposing first and second major surfaces;
said core comprising a monolithic body of aerated concrete; and
at least one water vapor-permeable, water-resistant face layer secured on at least one of the first and second major surfaces of said core.

2. The exterior wallboard sheet according to claim 2 wherein said at least one water vapor-permeable, water-resistant face layer comprises at least one microporous polymer layer.

3. The exterior wallboard sheet according to claim 2 wherein said at least one microporous polymer layer comprises at least one woven polypropylene fabric layer having a plurality of microperforations therein.

4. The exterior wallboard sheet according to claim 1 wherein said at least one water vapor-permeable, water-resistant face layer comprises ultraviolet light-resistant outer surface portions.

5. The exterior wallboard sheet according to claim 4 wherein said ultraviolet light-resistant outer surface portions comprise an ultraviolet light-resistant polyolefin.

6. The exterior wallboard sheet according to claim 1 wherein said core further comprises a pair of opposing side edges; and wherein said at least one vapor-permeable, water-resistant face layer extends around the opposing side edges.

7. The exterior wallboard sheet according to claim 1 further comprising an adhesive layer securing said at least one vapor-permeable, water-resistant face layer to adjacent portions of said core.

8. The exterior wallboard sheet according to claim 1 wherein said core comprises a monolithic body of autoclaved aerated concrete having a density of about 25 to 40 lbs./ft³.

9. An exterior wallboard sheet comprising:
a core having opposing first and second major surfaces;
said core comprising a monolithic body of aerated concrete; and
at least one water vapor-permeable, water-resistant face layer adhesively secured on the first and second major surfaces of said core;
said water vapor-permeable, water-resistant face layer comprising at least one microporous polymer layer.

10. The exterior wallboard sheet according to claim 9 wherein said at least one microporous polymer layer comprises at least one woven polypropylene fabric layer having a plurality of microperforations therein.

11. The exterior wallboard sheet according to claim 9 wherein said at least one water microporous polymer layer comprises ultraviolet light-resistant outer surface portions.

12. The exterior wallboard sheet according to claim 11 wherein said ultraviolet light-resistant outer surface portions comprise an ultraviolet light-resistant polyolefin.

13. The exterior wallboard sheet according to claim 9 wherein said core further comprises a pair of opposing side edges; and wherein said at least one microporous polymer layer extends around the opposing side edges.

14. The exterior wallboard sheet according to claim 9 wherein said core comprises a monolithic body of autoclaved aerated concrete having a density of about 25 to 40 lbs./ft³.

15. A method for making an exterior wallboard sheet comprising:
forming a core having opposing first and second major surfaces and comprising a monolithic body of aerated concrete; and
securing at least one water vapor-permeable, water-resistant face layer on at least one of the first and second major surfaces of the core.

16. The method according to claim 15 wherein the at least one water vapor-permeable, water-resistant face layer comprises at least one microporous polymer layer.

17. The method according to claim 16 wherein the at least one microporous polymer layer comprises at least one woven polypropylene fabric layer having a plurality of microperforations therein.

18. The method according to claim 15 wherein the at least one water vapor-permeable, water-resistant face layer comprises ultraviolet light-resistant outer surface portions.

19. The method according to claim 18 wherein the ultraviolet light-resistant outer surface portions comprise an ultraviolet light-resistant polyolefin.

20. The method according to claim 15 wherein the core further comprises a pair of opposing side edges; and wherein the at least one vapor-permeable, water-resistant face layer extends around the opposing side edges.

21. The method according to claim 15 wherein securing comprises adhesively securing the at least one vapor-permeable, water-resistant face layer to adjacent portions of the core.

22. The method according to claim 15 wherein the core comprises a monolithic body of autoclaved aerated concrete having a density of about 25 to 40 lbs./ft³.
